(19) United States
(12) Patent Application Publication
(10) Pub. No.: US 2005/0075473 A1
(43) Pub. Date: Apr. 7, 2005

(54) Telechelic emissive oligiomers and polymers derived therefrom

(76) Inventor: James A. Cella, Clifton Park, NY (US)

Correspondence Address: Fay, Sharpe, Fagan, Minnich & McKee, LLP, Seventh Floor, 1100 Superior Avenue, Cleveland, OH, 44114, US

(21) Appl. No.: 10/680,470

(22) Filed: Oct. 7, 2003

(51) Int. Cl. C08G 2/00

(52) U.S. Cl. 528/86

(57) ABSTRACT

The present invention is directed to a telechelic emissive, semi-conductive end-functionalized oligomers which can be polymerized by a variety of conventional techniques to afford emissive polymers. The polymers are useful as active layers in light emitting as well as photovoltaic devices.

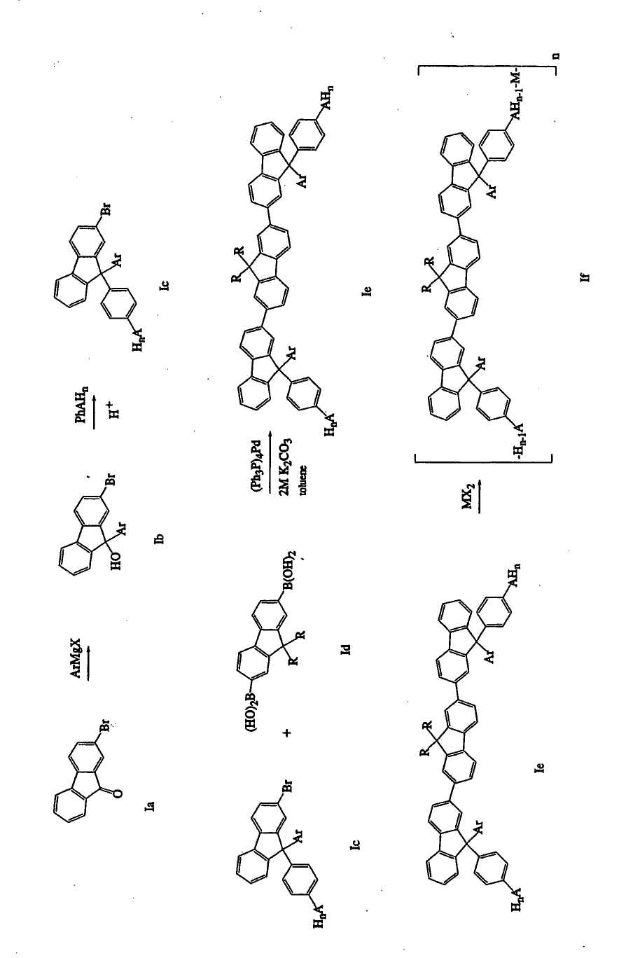

### BACKGROUND OF THE INVENTION

1. Field of the Invention

The present invention is directed to telechelic emissive, semi-conductive end-functionalized oligomers which can be polymerized by a variety of conventional techniques to afford emissive polymers. The polymers are useful as active layers in light emitting as well as photovoltaic devices.

2. Discussion of the Art

Polyphenylenes, polyfluorenes and other conjugated aromatic polymers are well known as active layers in electroluminescent devices. See U. Scherf and E. J. List, Adv. Mater., 14 (7), 477 (2002), and M. T. Bemius, M. Inbasekaran, J. O'Brien and W. Wu, Adv. Mater., 12 (23), 1737 (2000). These polymeric materials are generally prepared using aromatic coupling reactions, such as the Suzuki or Stille coupling or the nickel catalyzed coupling reactions of aryl halides. Although the methodology for preparing these polymers has been well established, in many cases the coupling-polymerization reactions afford by-products that limit the molecular weight and may either quench fluorescence or induce significant red shifts in the emission spectrum, thus limiting the color tunability of the devices.

Electroluminescent polymers bearing linking groups have been prepared and converted to electroactive copolymers by various methods. See C. Schmitt, H. G. Nothofer, A. Falcou and U. Scherf, Macromol. Rapid Commun., 22, 624 (2001); T. Miteva, A. Meisel, W. Knoll, H. G. Nothofer, U. Scherf, D. C. Muller, K. Meerholz, A. Yasuda and D. Neher, Adv. Mater., 13 (8), 565 (2001); and R. Friend, J. Burroughs and D. Bradley, U.S. Pat. No. 5,427,190 (1993) issued to Cambridge Display Technologies. The polymers in this invention are derived from phenol, thiophenol or aryl amine end-functional oligomers that can be converted into a variety of copolymers via these functional moieties. The oligomers or copolymers prepared according to the methods described are not believed to be known in the existing art.

### BRIEF SUMMARY OF THE INVENTION

In accordance with a first aspect of the invention, a process to prepare end-functionalized conjugated oligomers of polyarylenes that can be polymerized via the reactive end-group is provided.

A further aspect of the invention relates to the reaction of a phenol, thiol or amine functional moiety, which is substituted with either an aryl halide or an aryl boronic acid or ester, with either a bis-boronic acid or ester or a bis-haloarene using Suzuki coupling conditions to form the end-functionalized conjugated oligiomers of polyarylenes.

Another aspect of the invention relates to polymerization of the end-functionalized conjugated oligiomers of polyarylenes prepared according to the invention by reacting the phenol, thiol or amine functional moiety of the oligiomer with a difunctional monomer to form the polymer.

An additional aspect of the invention relates to the telechlic emissive, semi-conductive end-functionalized oligiomers and polymers produced therefrom.

A further aspect of the invention relates to the use of the emissive polymers of the invention in the formation of films for use in, for example, light emitting and photovoltaic devices.

These and other aspects and objects of the invention will become apparent upon reading and understanding of the detailed description of the invention.

### BRIEF DESCRIPTION OF THE DRAWINGS

The invention may take form in various components and arrangements of components, and in various steps and arrangement of steps. The drawings, in which like reference numerals denote like components through the views, are only for purpose of illustrating particular embodiments and are not to be construed as limiting the invention.

The FIGURE illustrates, in a schematic format, one embodiment of a process for preparing the oligiomers and corresponding polymers of the invention.

### DETAILED DESCRIPTION OF THE INVENTION

The present invention is directed to a family of telechelic oligomers, polymers derived from them, and to an efficient process to prepare end-functionalized conjugated oligomers. There are a number of advantages to the approach described in this disclosure. For example, the telechelic oligomers can be readily purified by conventional techniques (chromatography, recrystallization, etc.). Also, the emissive components of the oligomers can be readily varied to achieve desirable processability characteristics, color emission, emission efficiency and charge transport properties. Further, the conjugation length is readily tailored and the polymerization chemistry can be selected to minimize side reactions, maximize molecular weight control and tailor physical properties of the final polymer.

The oligomers of the invention are prepared by reaction of a phenol, thiophenol or amine functional moiety, appropriately substituted with either an aryl halide or an aryl boronic acid or ester, with either a bis-boronic acid or ester or a bis-haloarene respectively using Suzuki coupling conditions as described in N. Miyaura, T. Yanagi and A. Suzuki, Synth. Commun., (11) 513, (1981). The resulting oligomers can then be purified using conventional techniques. The purified oligomers may then be polymerized by reactions of the phenol, thiol or amine functional group with appropriate co-monomers to afford, for example, polycarbonates, polyesters, polyethers, polysilylethers, polyetherimides, polyimides. The resulting polymers can be isolated and fabricated into films or other media suitable for construction of devices such as light emitting devices and photovoltaic devices.

Additionally, the present invention is directed to polymers, and active layers of certain devices, such as light emitting devices, or photovoltaic devices, that are prepared from the process of the invention.

A schematic example of this concept is illustrated in the FIGURE. In this scheme, Ar represents any aromatic moiety including, but not limited to phenyl, substituted phenyl, naphthyl, anthryl, biphenylyl, etc., and any substituted variants of these species. “A” can be oxygen, sulfur or nitrogen, “n” is 1 or 2 depending on A. R may be, independently, alkyl, branched alkyl, hydrocarbon chains having 1 to about 40 carbon atoms, alkyl chains substituted with fluorine, cyano or aryl groups, aryl or substituted aryl. Additionally, Ar and the aryl ring bearing the AHn may be connected to each other by a carbon or carbon-heteroatom bond, such as in structures 1 and 2.

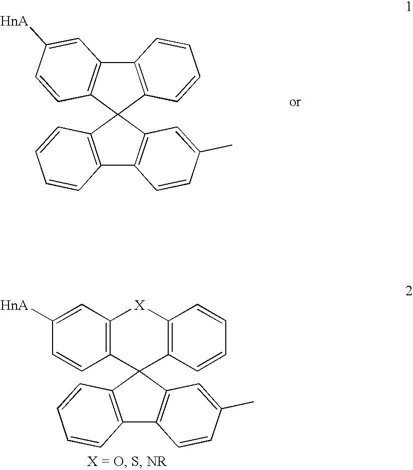

Likewise, the R groups may be linked together as in structure 3.

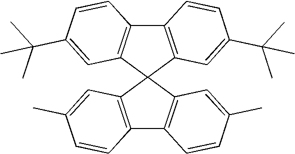

The AHn functional group used for linking these oligomers together may also be attached to other portions in this oligomer, such as in structure 4.

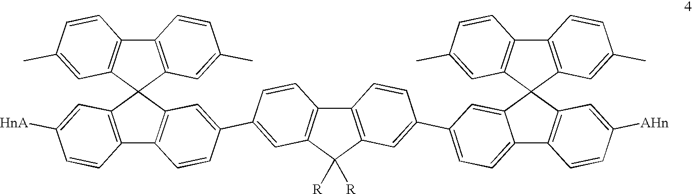

Additionally, the oligomer length can be extended as in the generic structure 5.

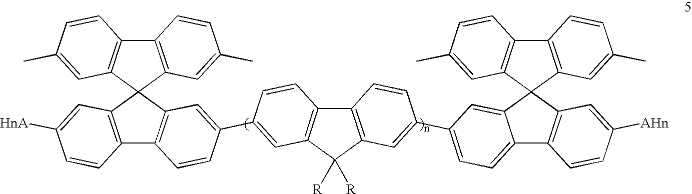

Further, some of the polymers described herein may also be obtained by first linking the AHn functional components together via a carbonate, or other suitable linkage, and then polymerizing through the arylhalide function using typical aryl coupling chemistry, such as described by Suzuki or Yamamoto previously referenced herein. Such a method would essentially be a reversal of the order of events to obtain the desired materials. This process is shown in the following scheme:

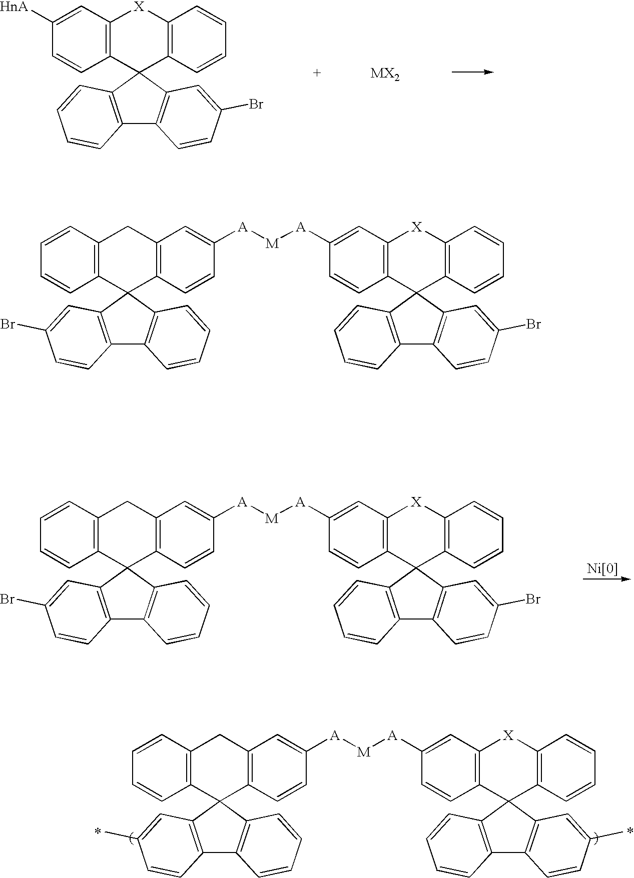

MX₂ is any difunctional monomer capable of reacting with AHn to form a homopolymer or copolymer. Examples of MX₂ include but are not limited to BPA-bis-chloroformate, terephthalic acid or its diacid chloride, dichlorophenylsulfone, pyromellitic dianhydride, adipoylchloride, diphenyldichlorosilane, dimethyldichlorosilane, 1,1,3,3-tetramethyldisiloxane, phosgene and the like, and mixtures thereof.

The “homopolymer” in this context means that the emissive segments are linked together solely by the linker MX₂. See, for example, structure 6. The “copolymer” in this context refers to structures wherein one or more emissive segments and/or a non-emissive segments are linked together by the link MX₂. The link segments in a copolymer can be dispersed randomly or in an alternating manner. The latter is referred to as an alternating copolymer, which is often abbreviated “alt-w-polymer.” Structures 6 and 7 are illustrative of these types of structures:

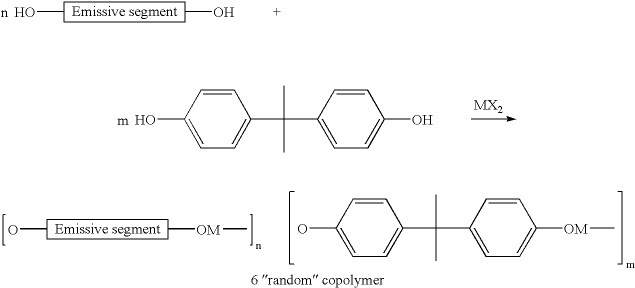

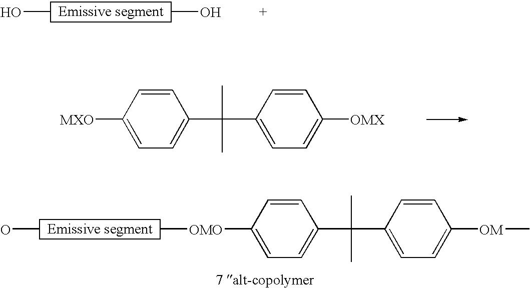

In the schematic shown in the FIGURE, the starting material, a halogenated fluorenone such as 2-bromo-fluorenone (Ia), can be prepared by known procedures such as that described in J. Chem. Soc., p 1737, (1970) and by direct bromination of fluorenone in the presence of Fe and methylene chloride. Halogenation may take place at more than one position on the fluorenone ring system as in, for example, 2,7-dibromo-fluorenone.

The halogenated fluorenone (Ia) is then converted into intermediate reaction product (lb) via a Grignard reaction. In the schematic shown in the FIGURE, a Grignard reactant ArMgX where Ar represents any aromatic moiety including, but not limited to, phenyl, substituted phenyl, maphthyl, anthryl, biphenylyl, etc. and any substituted variants thereof, and X is halogen, is reacted with the halogenated fluorenone (Ia) to produce an intermediate reaction product, such as the carbinol of formula (Ib) as shown in the FIGURE.

The carbinol of formula (Ib) is then reacted with a phenol, thiol or amine functional moiety. In the scheme of the FIGURE, the carbinol is reached with a phenyl ring having OH, SH, or NH₃ attached thereto which forms the compound of formula (Ic). While the compound (Ic) in the FIGURE has an aryl halide substitution, this derivative may be converted to an aryl boronic acid or ester prior to the coupling step.

The compound of formula (Ic) is then reacted with either a bis-boronic acid or ester or a bis-haloarene under conventional Suzuki coupling conditions as mentioned hereinbefore. In the reaction scheme of the FIGURE, a bis-boronic acid of Formula (Id) is reacted with the compound of Formula (Ic) in the presence of (Ph₃P)₄, K₂CO₃ and toluene to form the oligiomer of Formula (Ie)

The oligiomer of Formula (Ie) can then be polymerized by reacting the phenol, thiol or amine functional moiety with an appropriate co-monomer(difunctional monomer). The comonomer as shown in the reaction scheme of the FIGURE has a formula MX₂ and is for example, phosgene. As shown in the FIGURE, the resultant polymer is a compound of Formula (If).

In one embodiment a polymer of the general formula:
[(D-Gₙ-D)-M]ₘ
is formed in accordance with the present invention. D is preferably an “A-functional” segment of the general formula:
   Ar-A-Hₐ
wherein Ar is an aromatic unit selected from the group consisting of phenyl, substituted phenyl, naphthyl, anthryl, biphenyl, substituted variants thereof, and mixtures thereof; A is selected from the group consisting of oxygen, nitrogen, sulfur, nil, and mixtures thereof; wherein “nil” represents a conjugation length of (D-Gₙ-G) that is interrupted by the A-M linkage and is an integer between about 1 and 3; G is preferably an oligophenylene, such as oligofluorene, as previously described; n is preferably an integer between about 1 and about 25, M is a linking group formed by reacting the emissive segment with a MX₂ linker as previously described, and m is an integer between about 1 and about 1000.

The following examples are meant for illustrative purposes only and are not intended to limited the invention to the particular embodiments described therein:

### EXAMPLES

### Example 1

### Preparation of Coumpound 1(f) from the FIGURE where R=n-hexyl, Ar=4-t-butylphenyl, A=O and MX₂=phosgene

A Grignard reagent prepared from 4.47 g. (21 mmol) of 4-t-butylbromobenzene and 0.753 g. (31 g-atoms) of magnesium plus 10 mmol of 1,2-dibromoethane in 50 ml of ether was treated over one hour with a hot solution of 5.18 g. (20 mmol) of 2-bromofluorenone in 25 ml. of toluene. The mixture was refluxed for one hour then quenched by addition of 50 ml. of saturated aqueous ammonium chloride. After separation and washing of the organic layer, solvent was evaporated to yield 10 g. of an oil that was chromotographed on 50 g. of silica gel (20% ethyl acetate-hexane as eluant). The product was a carbinol which was then isolated as an off-white solid in 92% yield. Reaction of this carbinol, (15.5 mmol) with 1.5 equivalents of phenol in methylene chloride (10 ml.) in the presence of 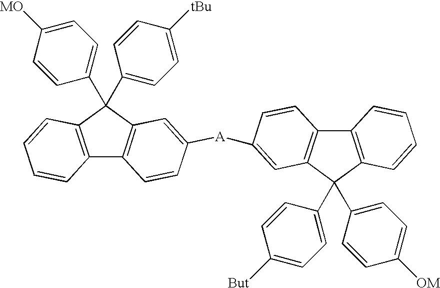
methanesulfonic acid (200 μl) afforded 2-bromo-9-(4-t-butylphenyl)-9-(4-hydroxyphenyl)fluorine (61%) yield. Reaction of the 2-bromo-9-(4-t-butylphenyl)-9-(4-hydroxyphenyl)fluorine compound with 0.5 equivalents of 9,9-dihexyl-2,7-bis-trimethyleneborate in a toluene/2M K₂CO₃ mixture in the presence of hexaethylguanidinium chloride (1 mol %) and tetrakis-triphenylphosphine palladium(0) (1.6 mol %) afforded the terfluorene bisphenol (68% yield). Mass spectrum: m/e 1110 (M*). Reaction of this bis-phenol with one equivalent of phosgene in methylene chloride in the presence of a pH 10 buffer afforded approximately an 80% yield of polymer 1(2) gpc (PS standards) Mw=25025; Mn=7808 Mw/Mn=2.96.

Other functional monomers and polymers have been prepared using procedures similar to that described above. A summary of pertinent data for these materials is presented in Table 1.

TABLE 1
Pertinent data for oligomers and polymers

| A | M | Mw | Mn | Mw/Mn | Uv(max) | Emm(max) |
|---|---|---|---|---|---|---|
| 9,9- | H | 1,110 | 1,110 | 1.00 | 350 | 400,425 |
| dihexylfluorene- | | | | | | |
| 2,7-diyl | | | | | | |
| 9,9- | CO | 43,237 | 15,014 | 2.88 | 350 | 400,425 |
| dihexylfluorene- | | | | | | |
| 2,7-diyl | | | | | | |
| 9,9- | CO/ | 35,818 | 15,273 | 2.34 | 350 | 400,425 |
| dihexylfluorene- | (OBPAOCO) | | | | | |
| 2,7-diyl | | | | | | |
| 9,9- | COOBPAOCO | 20,098 | 8464 | 2.37 | 354 | |
| dihexylfluorene- | | | | | | |
| 2,7-diyl | | | | | | |
| 9,9- | Ph₂Si | <15,000 | <5,000 | — | — | |
| dihexylfluorene- | | | | | | |
| 2,7-diyl | | | | | | |
| — | H | 778 | 778 | 1.00 | 334 | |
| — | COOBPAOCO | 42,917 | 9307 | 4.61 | 333 | |
| Oxa^{a} | H | 998 | 998 | 1.00 | 347 | |
| Oxa^{a} | COOBPAOCO | 28,547 | 12,309 | 2.32 | | |
| 9,10-anthryl | H | 954 | 954 | 1.00 | 382,407 | |
| 9,10-anthryl | COOBPAOCO | 31,942 | 13,420 | 2.38 | 383,399 | |

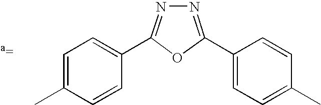

In addition to the above, the following tables 2 and 3 illustrate other monomeric and polymeric structures of compounds within the scope of the invention, a number of physical properties associated with the monomers and polymers are also represented in the tables below.

TABLE 2
Monomers

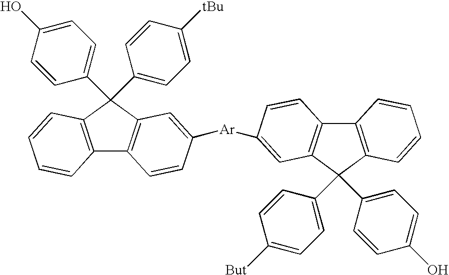

| | | mp | λₘₐₓ(abs) | λₘₐₓ(em) | | ΔE(uv) |
|---|---|---|---|---|---|---|
| Ar | MW | ° C. | (nm) | (nm) | φem | (eV) |
| 2.1 | 1110 | 198-220 | 350 | 398,416 | 0.93 | 3.11 |
| 2.2 | 954 | 222-232 | 382 | 442 | 0.39 | 2.87 |
| 2.3 | 998 | 235-258 | 347 | 393,410 | 1.08 | 3.19 |
| — | 778 | 230-235 | 334 | 416 | 0.93 | 3.08 |

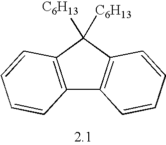

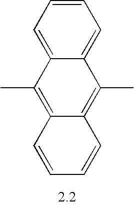

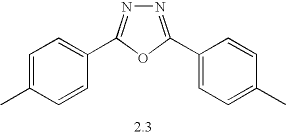

TABLE 3
Polymers

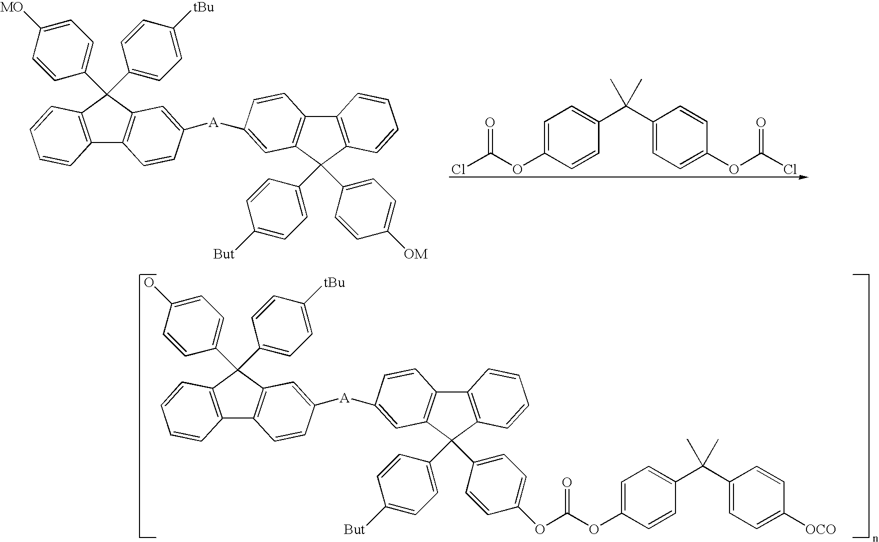

| | | | λₘₐₓ(abs) | λₘₐₓ(em) | | ΔE(uv) |
|---|---|---|---|---|---|---|
| Ar | MW | Mn | (nm) | (nm) | φem | (eV) |
| 3.1 | 20,098 | 8464 | 354 | 398,416 | 0.86 | 3.14 |
| 3.2 | 31,942 | 13,420 | 383,399 | 439 | 0.39 | 2.86 |
| 3.3 | 28,547 | 12,309 | 347 | 393,410 | 1.06 | 3.19 |
| — | 42,917 | 9307 | 333 | 387 | — | 3.35 |

| | | |
|---|---|---|
| 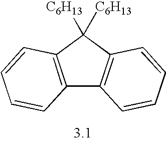 | 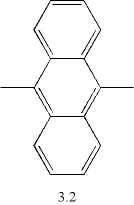 | 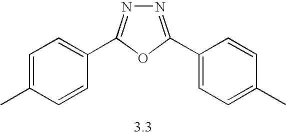 |

Additionally, several polymers were prepared according to the following scheme: 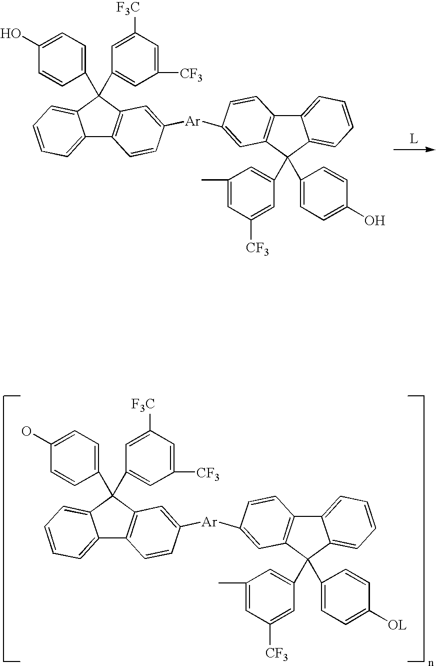
wherein Ar is: 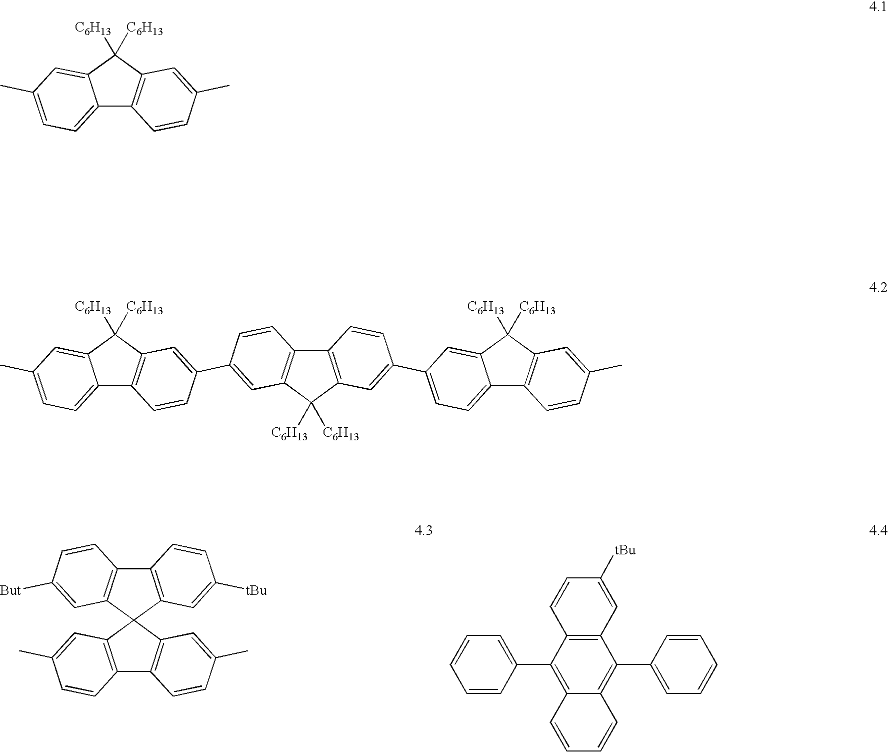
and L is:

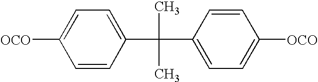

Polymers were also prepared according to the following scheme: 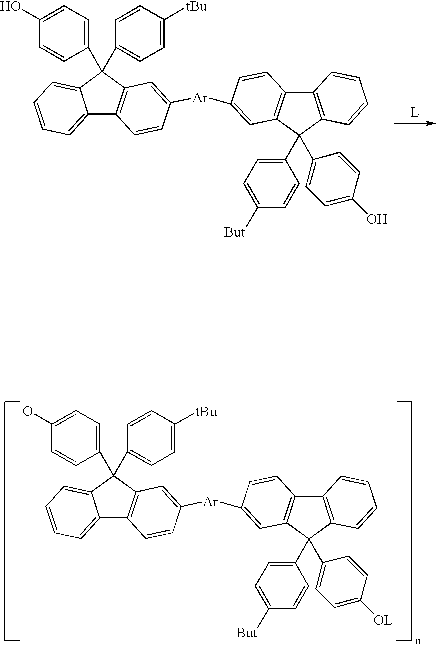
wherein Ar is the same as 2.1 previously set forth herein, and L is:

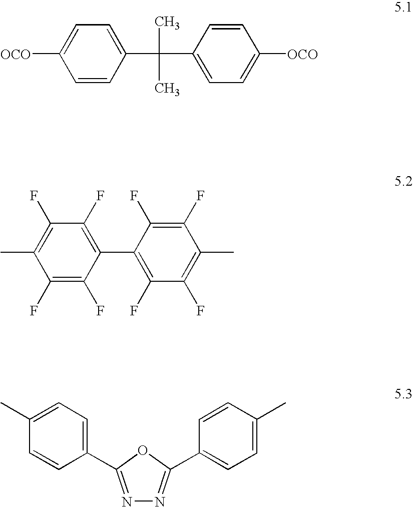

Additionally, with respect to the foregoing scheme, a polymer was formed using a co-monomer and structure 4.1. The co-monomer had the following structure:

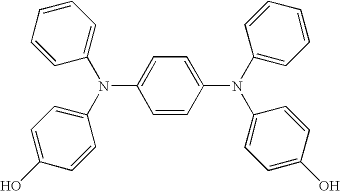

Several polymers were prepared and tested in a device having the layered structure ITO/PEDOT/X/LiF/Al were X is the polymer according to the invention. The X polymer was prepared by reacting on oligiomer of the formula:

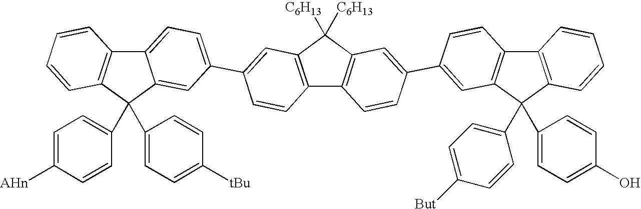

with a difunctional monomer as defined in the Table 4 below.

TABLE 4
Device Data

| | | W/W | | | |
|---|---|---|---|---|---|
| Difunctional | | @ 20 mA/ | | | |
| Monomer | Turn on V | cm² | LPWr | CIEx | CIEy |
| Homo-PC | 6.05 | 0.062% | 229 | 0.222 | 0.297 |
| Co-BPA PC | 6.9 | 0.019% | 170 | 0.208 | 0.228 |
| Alt-BPA PC | | — | — | — | — |
| Diphenylsilylether | 5.4 | .025% | 335 | 0.176 | 0.143 |
| CDTF1 | 3.11 | 0.23 | 130 | 0.173 | 0.138 |

In table 4, turn on V is the voltage at which the device emits visible light, W/W@20 mA/cm², LPWr is lumens per watt, CIEx and CIEy are coordinates describing the color of the emitted light.

While the invention has been described herein relative to its preferred embodiments, it is of course contemplated that modifications of, and alternatives to, these embodiments, such modifications and alternatives obtaining the advantages and benefits of this invention, will be apparent to those of ordinary skill in the art having reference to this specification. It is contemplated that such modifications and alternatives are within the scope of this invention as subsequently claimed herein.

1. A process for preparing an end-functionalized conjugated oligomer of a polyarylene comprising the steps of:
a) effecting a reaction between a compound comprising a phenol, thiol or amine functional moiety which is substituted with an aryl halide or aryl boronic acid or ester, and a compound selected from a bis-boronic acid or ester or a bis-haloarene to form an oligiomer;
b) isolation and purification of the oligomer.

2. The process of claim 1 wherein the phenol, thiol or amine functional moiety is reacted with a compound having the formula: 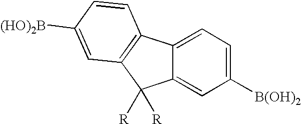
wherein each R is selected from the same or different moiety selected from straight or branched alkyl, substitute alkyl, aryl or substituted aryl radicals.

3. The process of claim 1 wherein the phenol, thiol or amine functional moiety is a compound of the formula: 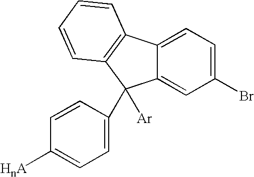
wherein Ar is an aromatic moiety, A is O, S or N and n is 1 or 2.

4. The process of claim 3 wherein the Ar aromatic moiety is selected from phenyl, substituted phenyl, naphthyl, substituted naphthyl, anthryl, substituted anthryl biphenylyl, and substituted biphenylyl.

5. The process of claim 2 wherein the resulting oligomer has the formula: 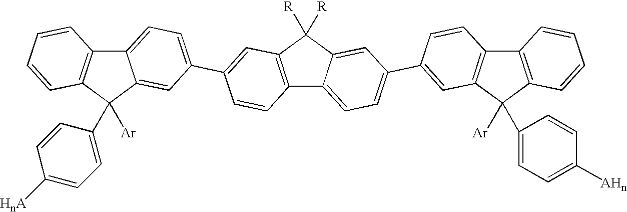
wherein Ar is an aromatic moiety, A is O, S or N, n=1 or 2 and each R is selected from the same or different moiety selected from straight or branched alkyl, substituted, straight or branched alkyl, aryl or substituted aryl.

6. The process of claim 5 wherein the Ar aromatic moiety is selected from phenyl, substituted phenyl, naphthyl, substituted naphthyl, anthryl, substituted anthryl biphenylyl, and substituted biphenylyl.

7. A process for forming a polymer comprising a series of end functionalized conjugated oligomers of a polyarylene comprising the steps of:
a) effecting a reaction between a compound comprising a phenol, thiol or amine functional moiety which is substituted with an aryl halide or aryl boronic acid or ester, and a compound selected from a bis-boronic acid or ester or a bis-haloarene to form an oligiomer having an amine thio or amine functional moiety formed thereon;
b) isolation and purification of the oligomer having an amine thio or amine functional moiety formed thereon; and
c) reacting the phenol, thiol or amine functional moiety present on the oligiomer of step b) with a difunctional monomer to form a polymer.

8. The process of claim 7 wherein the phenol, thiol or amine functional moiety on the compound of step a) is reacted with a compound having the formula: 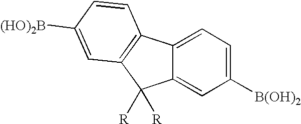
wherein each R is selected from the same or different moiety selected from straight or branched alkyl, substitute alkyl, aryl or substituted aryl radicals.

9. The process of claim 7 wherein the compound comprising a phenol, thiol or amine functional moiety in step a) is a compound of the formula: 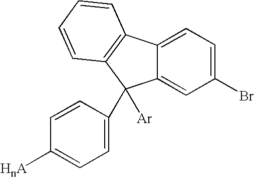
wherein Ar is an aromatic moiety, A is O, S or N and n is 1 or 2.

10. The process of claim 9 wherein the Ar aromatic moiety is selected from phenyl, substituted phenyl, naphthyl, substituted naphthyl, anthryl, substituted anthryl biphenylyl, and substituted biphenylyl.

11. The process of claim 9 wherein the resulting oligomer has the formula: 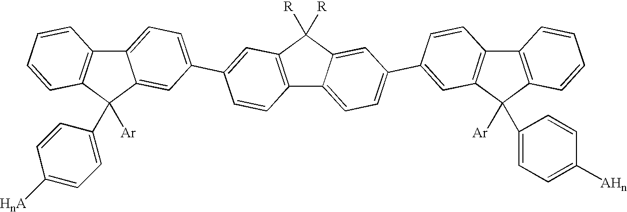
wherein Ar is an aromatic moiety, A is O, S or N, n=1 or 2 and each R is selected from the same or different moiety selected from straight or branched alkyl, substituted, straight or branched alkyl, aryl or substituted aryl.

12. The process of claim 11 wherein the Ar aromatic moiety is selected from phenyl, substituted phenyl, naphthyl, substituted naphthyl, anthryl, substituted anthryl biphenylyl, and substituted biphenylyl.

13. The process of claim 12 wherein Ar is selected from 4-t-butylphenyl.

14. The process of claim 7 wherein the difunctional monomer is a compound selected from BPA-bis-chloroformate, terephthalic acid, terephthalic diacid chloride, dichlorophenylsulfone, pyromellitic dianhydride, adipolychloride, diphenyldichlorosilane, dimethyldichlorosilane, phosgene, 1,1,3,3-tetramethyldisiloxane and mixtures thereof.

15. The process of claim 5 wherein the oligomer of claim 5 is further polymerized with a difunctional monomer having the formula MX₂ to form a polymeric compound having the formula: 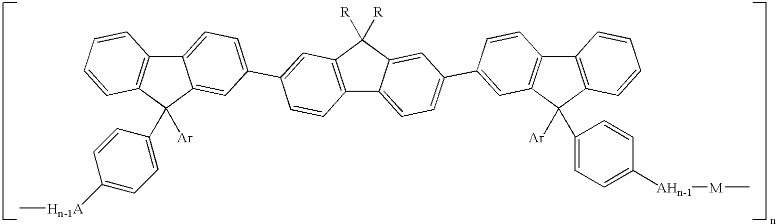
where MX₂ is a difunctional monomer which is capable of reacting with the AHn group to form a polymer.

16. The process of claim 15 wherein the MX₂ difunctional monomer is a compound selected from BPA-bis-chloroformate, terephthalic acid, terephthalic diacid chloride, dichlorophenylsulfone, pyromellitic dianhydride, adipolychloride, diphenyldichlorosilane, dimethyldichlorosilane, phosgene, 1,1,3,3-tetramethyldisiloxane, and mixtures thereof.

17. An end-functionalized oligomer produced by the process of claim 1.

18. A polymer prepared by the process of claim 7.

19. A light emitting device comprising an active layer, wherein said active layer is formed from a polymer produced in accordance with the process of claim 7.

20. A photovoltaic device comprising an active layer, wherein said active layer is formed from a polymer produced in accordance with the process of claim 7.

21. A polymer composition comprising a polymer of the general formula:
[(D-Gₙ-D)-M]ₘ,
wherein D is an “A-functional” segment of the general formula:
Ar-A-Hₐ,
wherein Ar is an aromatic unit, A is selected from the group consisting of O, N, and S, and a is an integer between about 1 and 3; G is an oligophenylene; n is an integer between about 1 and 25, M is a linking group, and m is an integer between about 1 and 1000.

22. The composition of claim 21 wherein said aromatic unit is selected from the group consisting of phenyl, substituted phenyl, naphthyl, anthryl, biphenyl, substituted variants thereof, and mixtures thereof.

23. The composition of claim 21 wherein said M is formed by reacting at least one MX₂ with the (D-Gₙ-D) segments.

24. The composition of claim 23 wherein said MX₂ is selected from the group consisting of BPA-bis-chloroformate, terephthalic acid and its diacid chloride, dichlorophenylsulfone, pyromellitic dianhydride, adipochloride, diphenyldichlorosilane, dimethyldichlorosilane, 1,1,3,3-tetramethyldisiloxane, phosgene, and mixtures thereof.
